(19) United States
(12) Patent Application Publication
(10) Pub. No.: US 2018/0230707 A1
(43) Pub. Date: Aug. 16, 2018

(54) Systems and Methods for Controlling the Vertical Position of a Building

(71) Applicant: Floodjack International Limited, Prestwich Greater Manchester (GB)

(72) Inventor: Andrew Parker, Manchester Greater Manchester (GB)

(21) Appl. No.: 15/751,433

(22) PCT Filed: Aug. 9, 2016
(86) PCT No.: PCT/GB2016/052474

§ 371 Date: Feb. 8, 2018

(30) Foreign Application Priority Data
Aug. 10, 2015 (GB) 1514083.3

(51) Int. Cl. E04H 9/14; B66F 3/08; B66F 3/46

(52) U.S. Cl. CPC E04H 9/145; E02D 27/32; B66F 3/46; B66F 3/08

(57) ABSTRACT

Systems and methods for controlling the vertical position of a building are disclosed. In one arrangement a system is provided in which a jacking system is capable of moving the building vertically relative to a foundation structure supporting the weight of the building and the jacking system comprises at least one screw jack. In another arrangement a system is provided in which a controller uses the jacking system to control the vertical position of the building in response to data about one or more physical properties of the environment in or around the building input to the controller.

### TECHNICAL FIELD

The present invention relates to controlling the vertical position of a building, particularly in response to flooding or a risk of flooding.

### BACKGROUND

Ever-increasing populations has made it desirable to make the best possible use of all available land. This has resulted in a pressure to build in less than ideal locations, including in regions prone to flooding. Many existing buildings are already located in such regions. An estimated 200,000 homes were built on flood plains or in flood risk areas in the UK between 2001 and 2011. Due to the shortage of suitable land to build affordable housing on, it is becoming necessary to look at how more land can be built on and most importantly still be insurable. Flooding is unpredictable and can cause significant damage when it occurs. People living in flood prone areas can find insurance difficult or expensive to obtain. Heavy precipitation events are likely to become more frequent in many regions in Europe, and sea-level rise is projected to accelerate compared to the twentieth century under all emissions scenarios. The result of this will be increased levels of flooding, which is expected to cause major disruption, displacing thousands of families and leaving businesses unable to trade. The cost of flooding to the British insurers alone is around £1 billion annually. Losses in the European Union have been estimated at £17 billion for 2013 alone.

Previous efforts to protect buildings from flooding can be grouped into three areas: resistance, resilience and avoidance.

Flood resistance prevents floodwater from entering the building and damaging its fabric. Examples include sandbags, ground pumps, non-return valves on water pipes and sealed doors. These may perform reasonably for short periods but houses that are likely to flood to a significant depth (500 mm of more) cannot use flood resistance as the house may collapse due to hydrostatic pressure.

Flood resilience involves constructing a building in such a way that although floodwater may enter the building its impact is reduced (i.e. no permanent damage is caused, structural integrity is maintained and drying and cleaning are facilitated). Elements damaged by floodwater are designed to be easily repaired or replaced.

Flood avoidance involves constructing a building and its surrounds (at site level) in such a way as to avoid it being flooded, such as building outside a flood risk area. Other methods include building houses on stilts. Permanently raising buildings can be unsightly however when flooding is not present, both for the owner and for neighbors. Planning permission for such projects can be difficult or impossible to obtain.

### SUMMARY

It is an object of the invention to provide an alternative approach to facilitate safer and/or increased use of flood-prone areas for buildings.

According to an aspect of the invention, there is provided a system for controlling the vertical position of a building, comprising: a jacking system capable of moving the building vertically relative to a foundation structure supporting the weight of the building, wherein the jacking system comprises at least one screw jack.

Thus, a system is provided in which the vertical position of a building relative to a foundation structure can be varied, for example to raise the building above flood waters. The use of a jacking system (rather than a permanent raising solution such as stilts) means that the vertical position can be changed dynamically. The building need only be raised when there is a heightened risk of flooding. When the risk of flooding is low the building can be lowered. The time for which the building is in a potentially unsightly raised state can therefore be minimized. Impact on neighbors is therefore reduced and planning permission is more likely to be obtainable.

Many jacking systems are available for raising heavy loads. The inventors have recognized that a jacking system based on screw jacks provides a particularly effective solution relative to more common types of jacking systems, such as hydraulic systems. Screw jacks are known for use in raising medium loads (e.g. a car) and for holding larger loads (but not generally for lifting them, due to the high friction associated with actuation of screw jacks under high load). The present inventors have recognized that screw jacks can be used for lifting larger loads when used in a coordinated system (i.e. with multiple screw jacks operating synchronously). The inventors have further recognized that there are distinct advantages relative to hydraulic alternatives, which might otherwise be considered for lifting a heavy load such as a building. A particular advantage is that screw jacks avoid the difficulties of maintaining a constant pressure which are associated with hydraulic systems, particularly where multiple jacks need to be used in parallel. Temporal or spatial variations in the jacking force, which might otherwise apply potentially damaging stresses on the building, can be reduced. Furthermore, screw jacks require relative little maintenance and are reliable over long periods in a variety of operating conditions, making them suitable for use in difficult to access regions beneath buildings in situations where the operating conditions may vary significantly through the year (including flooding, freezing and large variations in temperature). Screw jacks can be provided which do not need servicing for over 100,000 lifts. Screw jacks can be provided which are specifically designed to work underwater. Screw jacks are self-locking, which improves safety and stability. The spatial lifting accuracy of screw jacks is extremely high, which ensures uniform application of force to the building. Typical accuracies of better than 1 mm over the whole lift can be achieved using screw jacks. Different sized screw jacks can easily be constructed to suit the size and weight of the building to be jacked. Capacities of from 5 tons to 100 tons (−5 kN to 1 MN+) are possible. Multiple screw jacks having identical performance can be constructed easily, allowing smaller and cheaper individual jacks to be used and helping to spread the lifting force uniformly, which reduces stresses applied to the building Additionally, screw jacks are inherently more environmentally friendly than hydraulic systems because they do not contain any toxic hydraulic fluids. The jacking system is also particularly suitable for being implemented in such a way that the aesthetic of the structure when the system is not in use is not altered relative to when the jacking system is not present.

In an embodiment, the at least one screw jack comprises a plurality of screw jacks and the jacking system comprises a coupling mechanism configured to cause all of the plurality of screw jacks to rise or fall at the same rate when driven by a single power source. Screw jacks lend themselves particularly well to being coupled together in this manner. For example, each of the screw jacks may have the same thread pitch and be driven so that the screw of the screw jack rotates at the same speed relative to the thread. This arrangement makes it possible to apply a lifting force uniformly and reliably, minimizing the risk of stress to the building.

In an embodiment, each of the plurality of screw jacks is fixedly attached to the foundation structure. This ensures that the jacks cannot slip, and damage to the building from uneven forces is reduced. In a case where the foundation structure comprises a plurality of piles, each screw jack may be fixedly attached to, and/or positioned vertically above, a different one of the piles. A pile is an advantageous foundation substructure for use in flood-prone areas as it is driven deep into the ground, thereby providing a solid support even during flooding Fixedly attaching the screw jacks to the piles, for example such that each screw jack is vertically above a pile, ensures that the jacks have a solid foundation on which to support the weight of the building. The risk of damage to the building from uneven forces is reduced. Furthermore, such a system is highly adaptable and can be fitted to a number of pre-existing structures or structures under construction. However any foundation structure may be used with screw jacks.

In an embodiment, the system further comprises a remote device configured to provide an interface for a user to control operation of the jacking system remotely. A user can thus control the vertical position of the building regardless of whether the user is inside or at the location of the building. For example if the user is at work or on holiday, the user can still raise the building if the flood risk is high, without having to return to the building.

According to an aspect of the invention, there is provided a system for controlling the vertical position of a building, comprising: a jacking system capable of moving the building vertically relative to a foundation structure supporting the weight of the building; and a controller configured to use the jacking system to control the vertical position of the building in response to data about one or more physical properties of the environment in or around the building input to the controller.

In the event of a change in the risk of flooding or state of flooding, the system can therefore raise or lower the building with a degree of automation, without necessarily requiring any direct input from a user. The risk of flood damage can therefore be kept low while minimizing the amount of time the building is in a raised state, and minimizing the requirement for a user to be present and/or directly involved. Relative to an alternative approach in which the vertical position of a building is varied manually, reliability is improved and an average vertical position of the building can be reduced, even during periods of flooding. Unsightliness caused by the jacking process is therefore reduced.

In an embodiment, the system further comprises one or more sensors, the data about one or more physical properties of the environment comprising data obtained from the one or more sensors. The one or more sensors may be configured to measure physical properties of the environment at the location of the building (e.g. water level, temperature, air humidity or ground humidity) that are indicative of a current state of flooding or that are indicative of a future state of flooding. The sensors allow the system to respond autonomously and reliably to changes in a risk of flooding or state of flooding.

In an embodiment, the controller is further configured to transmit data received from the one or more sensors to a remote device. The data may be processed at the remote device, for example to calculate a risk of flooding, and data resulting from the processing may be sent back to the controller. Alternatively or additionally, the data may be displayed to a user at the remote device who may use the data to decide how to control the jacking system remotely (e.g. by raising or lowering the building in response respectively to an increase or decrease in a risk of flooding or state of flooding). The remote device may also obtain other data, such as meteorological data to assist the user further with the decision making process. The remote device may be computer or mobile device (telephone, tablet, etc.) connected to the controller via a network (internet, cellular network, etc.).

In an embodiment, the physical property used by the controller comprises a water level. The water level may be water level measured at the building or in a location near to the building. The water level may be a water level above ground or below ground. If the water level rises, the controller may calculate whether to respond by raising the building. If the water level falls, the controller may respond by calculating whether to lower the building. Using a sensor to measure a water level, which may be done continuously or at short intervals, makes it possible for the controller to respond reliably to changes in a risk of flooding or state of flooding and prevent flood damage.

In an embodiment, the physical property used by the controller comprises temperature. Flood water may be at a different temperature to the air or dry ground and/or couple to a temperature sensor differently (e.g. with a different thermal conductivity) than air or dry ground. A change in the output from a temperature sensor may therefore indicate the presence of flood water at the location of the sensor and thereby provide information about a risk of flooding or state of flooding. Temperature measurements may therefore be useful for preventing flood damage directly. Additionally or alternatively, temperature measurements may also be relevant to how the vertical position of the building may be changed for other reasons. For example, where temperatures fall near to or below 0 degrees Celsius, freezing of water in confined spaces, such as in water pipes, becomes possible, which can cause blockages and damage. Depending on the structure of the building, the extent to which the region beneath the house is exposed to cold temperatures of the environment may be dependent on the height of the building. For example, at higher positions the underneath of the building may tend to be more exposed to cold temperatures, therefore increasing the risk of undesirable freezing, particularly in lower regions of the building. The cost of heating the building may also be higher for higher positions of the building. Inputting temperature measurements to the controller allows the controller to respond to these risks identified by the inventors by adjusting the way the vertical position is controlled. For example, in cold weather indicated by lower temperature measurements the controller may be configured to raise the building by a lower amount in response to an increased risk or state of flooding than in warmer weather. The risk of flood damage can be kept acceptably low whilst also reducing a risk of damage due to freezing and/or reducing a cost of heating.

In an embodiment, the physical property comprises air humidity. The level of air humidity measured by a sensor may provide an early indication of flood risk, allowing the controller to respond for example even before a water level reaches the sensor measuring the air humidity.

In an embodiment, the physical property comprises ground humidity. At very high values of ground humidity it can be deduced that a ground water level has reached the sensor measuring the ground humidity. Lower levels of ground humidity can provide an indication of how far below the ground water level is relative to the sensor measuring the ground humidity, thereby allowing the controller to respond early to a rising ground water level.

In an embodiment, the data about one or more physical properties of the environment comprises information obtained by the controller from an external data source providing meteorological data. The meteorological data may include flood alerts, weather forecasts and other information relating to current and predicted environmental conditions such as precipitation, cloud cover, water levels, temperature, wind and humidity.

In an embodiment, the system further comprises a connection actuator configured to selectively connect to, and disconnect from, the building an external service supply line leading to the building, wherein the connection actuator is controllable by the controller. The external service supply line may comprise one or more of the following: electricity, gas, water, drainage. The controller is thereby able to selectively reduce the risk of damage or accident caused by a broken external supply line, which might otherwise be caused when the building is raised above a certain level or where the environmental conditions are such that a risk of such breakage is elevated (e.g. in extremely cold conditions). The controller may be configured to respond to input from one or more sensors that are configured to detect a breakage in a service supply line downstream of the connection actuator (for example by disconnecting the service supply line from the building at the connection actuator).

According to an aspect of the invention, there is provided a method of controlling the vertical position of a building, comprising: using a jacking system comprising at least one screw jack to move the building vertically relative to a foundation structure supporting the weight of the building.

According to an aspect of the invention, there is provided a method of controlling the vertical position of a building, comprising: using a jacking system to move the building vertically relative to a foundation structure supporting the weight of the building, wherein a controller controls the jacking system in response to data about one or more physical properties of the environment in or around the building input to the controller.

### BRIEF DESCRIPTION OF THE DRAWINGS

Embodiments of the invention will now be described, by way of example only, with reference to the accompanying drawings in which corresponding reference symbols indicate corresponding parts, and in which:

FIG. 1 is a schematic side sectional view of a building and components of a system for controlling a vertical position of the building;

FIG. 2 depicts communication between components of the system of FIG. 1;

FIG. 3 depicts a system for controlling a vertical position of a building in which meteorological data is provided by an external data source and a remote device is configured to communicate with a controller of the system located at the building; and

FIG. 4 is a schematic top sectional view of a coupling mechanism connecting a plurality of screw jacks.

FIG. 5 is a perspective view of a stabilizing and jacking system.

FIG. 6 is a top sectional view of a stabilizing and jacking system.

FIG. 7 is a perspective view of a bearing.

### DETAILED DESCRIPTION

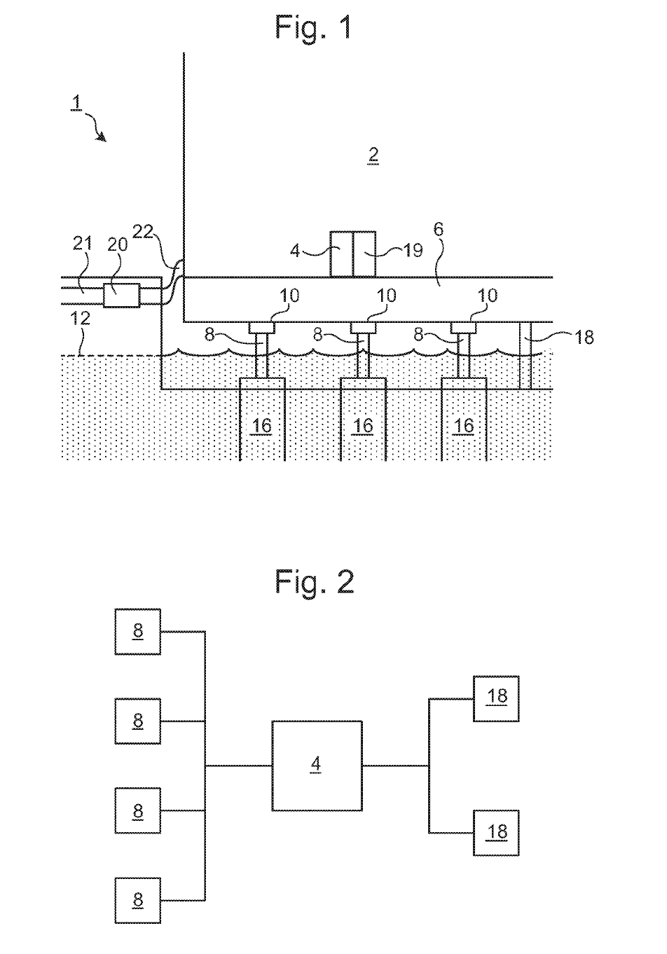

In an embodiment, there is provided a system 1 for controlling the vertical position of a building 2 relative to a foundation structure 16 supporting the weight of the building 2. The building may be a house, garage, bridge or any other type of permanent or temporary structure. Examples of such an embodiment are shown in FIGS. 1-4 and discussed below.

Typically, as shown in the example of FIGS. 1-4 (see FIGS. 1 and 4), the building 2 will include a platform 6 incorporated into a lower part of the building 2, or situated directly beneath the building 2. In the absence of the system for controlling the vertical position of the building 2, the platform 6 would engage directly against the foundation structure 16. The platform 6 may comprise a ring beam, formed from concrete, glass-reinforced plastic or steel for example. The structure of the platform 6 will depend on the specific size and shape of the building 2 but should be such as to support the weight of building 2 in an even manner, such that the building 2 can be lifted and lowered by applying forces solely to the platform 6, without transmitting damaging stresses (e.g. large shear stresses) to the rest of the building 2.

In an embodiment the foundation structure 16 comprises material sunk into the ground. The foundation structure 16 may be a strip foundation or may comprise one or more piles. In the example shown in FIGS. 1-4 the foundation structure 16 comprises a plurality of piles. Piles are particularly appropriate where building in areas at risk of flooding, as they tend to provide a more solid foundation that a strip foundation in these circumstances. The piles may be formed from concrete or any other suitable material. The piles may be located at strategic load points underneath the platform 6 in order to distribute the weight of the building 2 effectively using a relatively small number of large piles (as opposed to using a large number of smaller piles distributed more uniformly). Using a small number of large piles provides an effective foundation and also lends itself better to integration with the jacking system discussed below.

The system for controlling the vertical position of the building 2 comprises a jacking system capable of moving the building 2 vertically relative to the foundation structure 16. The foundation structure 16 will generally be fixed relative to the ground. Moving the building 2 relative to the foundation structure 16 therefore moves the building 2 relative to the ground.

In an embodiment, the jacking system comprises at least one screw jack 8. The term screw jack is understood to encompass so-called incremental screw jacks. A screw jack 8 is a type of jack where a lifting force is obtained by turning a screw (e.g. a lead screw) within a cooperating thread. Screw jacks can provide a highly constant lifting force and are self-locking. Screw jacks have various advantages in the context of dynamically changing the vertical position of the building, as discussed above in the introductory part of the description. However, other types of jack, e.g. hydraulic jacks, may be used in place of the screw jacks in any of the arrangements discussed herein.

In an embodiment, an example of which is shown in FIG. 4, the at least one screw jack 8 comprises a plurality of screw jacks 8 and the jacking system comprises a coupling mechanism 25 (e.g. a transmission system) configured to cause all of the plurality of screw jacks 8 to rise or fall at the same rate when driven by a single power source 23 (e.g. a motor). The coupling mechanism 25 may for example allow the power source 23 simultaneously to drive all of the screw jacks 8 in such a way that screws of the screw jacks 8 are rotated at an equal rate during a lifting or lowering process. Using such a coupling mechanism 25 and single power source 23 helps to ensure a uniform rate of lift at all points, minimizing the risk of damage to the building 2. Alternatively, one or more power sources 23 may be provided to actuate different groups of screw jacks 8 supporting the same structure. For example, one motor may be provided per screw jack 8 or per group of screw jacks. Thus a synchronized supporting system may be provided.

In an embodiment, each of the screw jacks 8 is fixedly attached to the foundation structure 16. A jack may therefore be stationary and a screw extendable vertically. The screw jacks 8 may also be fixedly attached to the building 2, for example to the platform 6. In this way a more reliable system may be provided, because the jacks are more easily accessible for maintenance and are less subject to water damage. A screw may be fixedly attached to a foundation, and the jack may move up and down the screw to alter a vertical position of the building. The attachment to either or both of the foundation structure 16 and building 2 may be made using various means, for example using bolts or by sinking a portion of the screw jacks into concrete or other material forming or attached to the foundation structure 16 or building 2. When in place the weight of the building 2 is supported by the jacks 8. The foundation structure 16 therefore supports the weight of the building 2 via the jacks 8. At least part of one of the jacks may be enclosed within the building, such as within the cavity walls. Where part of one or more jacks extends outside the building, the extended part may be enclosed within a cover member. Thus a more reliable system may be provided that is less vulnerable to damage by debris. The cover member may optionally be retractable, so as to only cover any exposed section of the jack.

In an embodiment in which the foundation structure 16 comprises a plurality of piles a plurality of screw jacks 8 may be provided in which at least one screw jack 8 is positioned above each pile. An example of such an embodiment is shown in FIG. 4. Here, the outline of a platform 6 of the building 2 is shown schematically by broken lines. In an embodiment, one and only one screw jack 8 is positioned over each of a plurality of the piles (not necessarily all of the piles). In an embodiment, one and only one screw jack 8 is positioned over each and every one of the piles present underneath the building 2 (as in the example of FIG. 4). The screw jacks 8 may or may not be fixedly attached directly (i.e. in contact with) the piles over which they are positioned. For example, in an embodiment a ground beam is positioned between the screw jacks 8 and the piles.

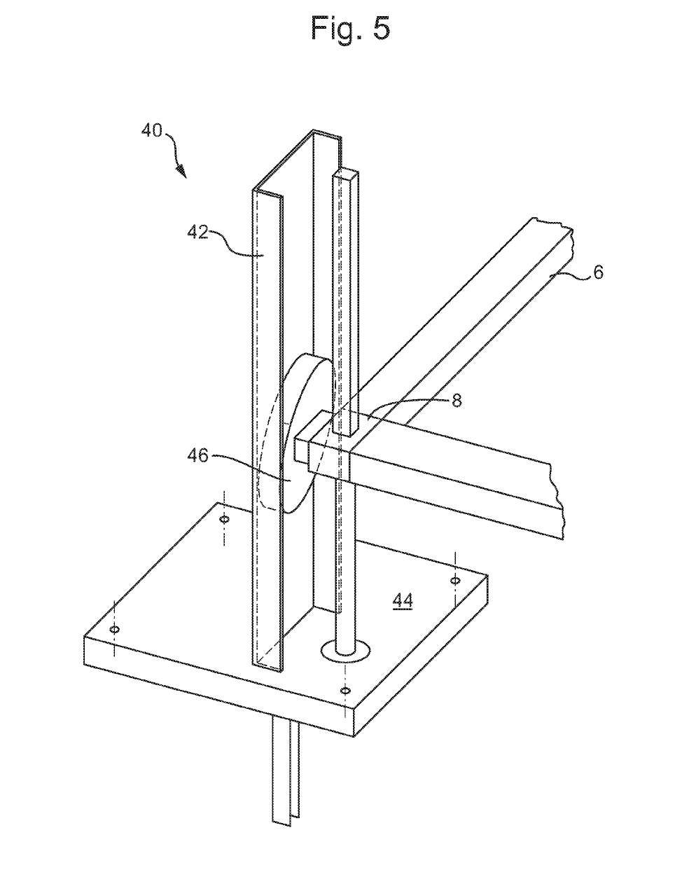

In an embodiment shown in FIG. 5, the system further comprises one or more rigid vertical members 40. Each jack 8 and rigid vertical member 40 may optionally be positioned inside the building. In this way a more discreet building vertical positioning system may be provided. Each rigid vertical member 40 may preferably comprise a rigid vertical channel 42 fixed to a foundation structure 44. One or more bearings 46 may preferably be located between the rigid vertical channel 42 and the building 2. The bearings 46 may be fixedly attached to the building 2 or platform 6. There is preferably a gap between the one or more bearings and the rigid vertical channel For example, there may be a gap of 1 mm between the one or more bearings 46 and the rigid vertical channel 42 when the building 2 is not experiencing any lateral forces. The one or more bearings 46 may preferably be positioned away from the rigid vertical channel 42, and configured to press against a surface 48 of the channel 42 when a position of the bearing 46 deviates by a threshold amount from a target lateral position, thereby transmitting a lateral stabilizing force to the building 2 via the rigid vertical member 40. Thus a more reliable and safer system may be provided. For example, wind or tidal surge may provide significant lateral forces on the building 2 during lifting or when at a fixed vertical position. These lateral forces can result in great strain on the building 2 and uneven loading on the jacks 8. By providing a lateral stabilizing force through the one or more bearings 46, the rigid vertical channel 42 can minimize any stresses on the building structure, and ensure that equal loads are carried by each of the jacks 8. This not only prolongs the longevity of the jacks 8, but also minimizes any damage to the building 2 when strong external lateral forces are present, and enables smaller (and therefore cheaper and/or more compact) capacity jacks 8 to be used. There are additional advantages if the bearing 46 is not in constant contact with the rigid vertical channel 42. For example, the lack of friction between the bearing 46 and the rigid vertical channel 42 reduces the load on the power source 23 operating the jacks 8, and a gap between the bearing 46 and rigid vertical channel 42 minimizes the risk of foreign objects causing the system to jam. Thus a more reliable, safer, cheaper and/or more compact system may be provided that minimizes damage to the building 2 both when the building is stationary and being repositioned vertically.

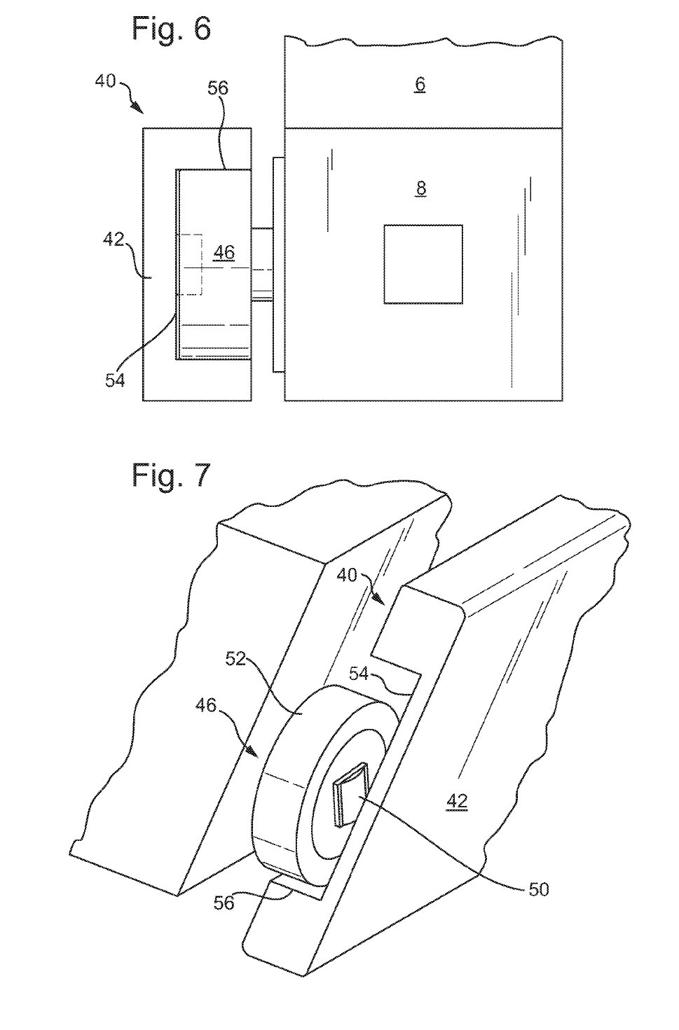

As shown in FIGS. 6 and 7, each bearing 46 may comprise multiple components 50, 52. Each bearing component 50, 52 may be arranged to engage with different sections of the rigid vertical channel when the lateral position of the building is outside a target lateral position. For example, each bearing 46 may comprise one or more components that engage rotatably with different surfaces 54, 56 of the rigid vertical channel 42. Where the rigid vertical channel 42 comprises a base surface 54 and a side surface 56, the bearing 46 may comprise a first component 50 that engages rotatably with the base surface 54 and a second component 52 that engages rotatably with the side surface 56. A single bearing may be thus provided that engages rotatably with one or more surfaces of the rigid vertical channel Each bearing 46 may be an axial/radial bearing (sometimes referred to as a Winkel bearing). The use of a single bearing 46 makes the system more compact, more reliable and easier to install into pre-existing structures.

In an embodiment the system further comprises a controller 4. The controller uses the jacking system to control the vertical position of the building 2 in response to data about one or more physical properties of the environment in or around the building 2. The data is input to the controller 4 via wires or using wireless transmission in the case where data is not generated at the controller 4 itself (e.g. by a sensor at the controller 4).

In an embodiment the system comprises one or more sensors 18. The one or more sensors obtain data about one or more physical properties of the environment in or around the building 2 and send the data to the controller 4 (if the one or more sensors 18 do not form part of the controller 4). One or more of the sensors 18 may be located in close proximity to the building 2, for example underneath the building 2, or in land belonging to the building 2, for example a garden. The one or more sensors 18 may take measurements at short time intervals or continuously. The one or more sensors 18 may measure one or more of the following: a water level, a temperature, air humidity, and ground humidity. Multiple sensors of the same type may be provided for redundancy. Therefore if one sensor of a particular type fails, another can be used to provide measurements. Advantages associated with each of these measurements are discussed in the introductory part of the description.

FIG. 2 illustrates an example communication architecture for an embodiment in which the system comprises a controller 4, a plurality of jacks 8 and a plurality of sensors 18. The connections between the controller 4, jacks and sensors 18 may be wired or wireless.

In an embodiment, the one or more sensors 18 comprises a conductive level sensor for measuring a water level. The level sensor may comprise a titanium or stainless steel rod, or a non-ferrous material. Alternatively or additionally, a submersible pressure transducer may be used to detect water and/or measure water level. Various level sensors using such rods and other measurement mechanisms are known in the art. Level sensors, including those comprising titanium or stainless steel rods, are available which not only detected water level but which also provide information about temperature and rate of water level rise.

The controller 4 may be configured to automatically raise or lower the building 2 in response to data indicating a changing risk of flooding or state of flooding (e.g. a changing water level 12 as measured by the one or more sensors 18). In an embodiment, the controller 4 changes the vertical position of the building 2 until a flood sensitive region of the building 2 is entirely above an existing water level 12 or a water level 12 which is expected to be reached in the near future, without excessively raising the building 2. In an embodiment the controller 4 calculates the vertical position to which the building 2 should be raised or lowered. In an embodiment the controller 4 includes a manual override to allow the user to choose a vertical position different from one which the controller 4 has selected. The controller 4 may also have pre-set maximum and minimum vertical positions that cannot be bypassed by the system or user. For example, the controller 4 may not allow the vertical position of the building to be set more than 2 m above ground level. Thus a safer system may be provided. The controller 4 may be further configured to provide a warning to nearby people when the vertical position of the building 2 is being changed. For example the controller may be configured to sound an alarm and/or flash lights if flooding is detected or if the building is in motion. The controller may be optionally be configured to display different colored lights for different states of the system. For example, a first color may be displayed when the vertical position of the building 2 is increasing, and a second color may be displayed when the vertical position of the building 2 is decreasing. The first color may optionally be red, and the second color may optionally be yellow.

Various algorithms may be used in the controller 4. Example approaches are discussed below.

In an embodiment the vertical position of the building 2 is increased from a first vertical position to a second vertical position when the controller 4 determines, based on the data input to the controller 4, that a probability of flood water reaching a first reference point in the building 2, if the building 2 were to remain at the first vertical position during a first reference time period, exceeds a first predetermined threshold probability. The first reference point may be any point on the building 2 but may preferably be a point up to which it is particularly undesirable for flood water to reach. For example, the first reference point may be at or near a position marking a boundary between a region of the building which would not be significantly damaged by flood water and a region of the building which would be significantly damaged by flood water (e.g. in or near living spaces).

The second vertical position may be selected such that the probability of flood water reaching the first reference point in the building 2, if the building 2 were to remain at the second vertical position for the first reference time period, is less than a second predetermined threshold probability.

In the same or another embodiment the vertical position of the building 2 is decreased from a third vertical position to a fourth vertical position when the controller 4 determines, based on the data input to the controller 4, that a probability of flood water reaching a second reference point in the building 2, if the building 2 were to remain at the fourth vertical position for a second reference time period, is less than a third predetermined threshold probability.

In an embodiment, the physical property comprises temperature and if the controller 4 determines that the building 2 should be lifted (i.e. positioned at a vertical position that is higher than a lowest position), for example because flood damage would be a risk otherwise, the height to which the building is lifted is lower if the temperature is determined to be below a predetermined temperature threshold than if the temperature is determined to be above the predetermined temperature threshold. The predetermined temperature may be at or near 0 degrees Celsius for example. Controlling the vertical position of the building 2 so that the building 2 is lower in times of cold weather may reduce the risk of damage due to freezing water and/or reduce heating bills, particularly where cold may enter the region underneath the building 2 to a greater extent the more the building 2 is raised above a lowest position. The predetermined temperature threshold may be a value between −10 and 5 degrees Celsius, optionally between −5 and 5 degrees Celsius, optionally between −2 and 2 degrees Celsius, for example.

In an embodiment the controller 4 may be configured to maintain the vertical position of the building at a constant height above the water level. In this way the controller 4 may automatically increase the vertical position of the building when a flood occurs, and automatically decrease the vertical position of the building as the flood waters subside.

In an embodiment the controller 4 may be configured to maintain the vertical position of the building if an emergency situation occurs. An emergency situation may be detected via user input or from sensor data. For example, the controller may be configured to receive data relating to the power used by the power source 23. If the controller determines that the power being supplied to the power source 23 is outside of a normal working range, the controller may stop the power source and maintain the vertical position of the building. Where the power source 23 is a motor, the controller may be configured to receive measurements of the current draw of the motor. Increased power usage by the power source suggests that an emergency situation may be present. For example, a tree or other object may have fallen on the building, thus making it more difficult for the power source to increase the vertical position of the building. In this scenario, increasing the vertical position of the building may further damage the building and therefore it is preferable to maintain the vertical position of the building. Alternatively, an object may be trapped between the building and the ground level. Therefore if the vertical position of the building were being lowered, the power source would again have to provide more power to overcome the obstacle. An abnormal amount of power being used by the power source is therefore a useful indicator that an emergency situation may be present. For example, a power spike of 10% or more of the usual power draw of the power source may be indicative of an emergency situation. The controller preventing operation of the power source and maintaining the vertical position of the building when an emergency situation is detected thus allows for a safer system to be provided.

The predetermined threshold probabilities mentioned above may be the same as or different from each other. The reference time periods may be the same as or different from each other. The reference points may be the same as or different from each other. Any combination of the predetermined threshold probabilities, reference time periods, reference points and vertical positions may be fixed (i.e. unchangeable) or changeable by a user (either at the controller 4 or remotely via a remote device, for example).

In an embodiment the system comprises a generator and/or battery 19 (see FIG. 1 for example) powerful enough to run the system without mains electricity, for example in case of a power cut. A generator and/or battery may also be provided for powering the one or more sensors 18 to ensure that data acquisition is possible in the case of a power cut.

In an embodiment the controller 4 is configured to transmit data received from the one or more sensors 18 to a remote device 22. The remote device 22 may be a computer or portable device such as a laptop, mobile phone, tablet, etc. The remote device 22 provides an interface (e.g. icons or text on a screen which can be interacted with by a user using an input device such as a keyboard or touch sensitive screen). The interface may provide information about a current state of the system, for example a current vertical position of the building 2 and/or outputs from one or more of the sensors 18. Alternatively or additionally the remote device 22 is configured to receive information from an external data source, for example meteorological data, such as flood alert information or weather forecasts (see below). In such an embodiment the interface may allow a user to access such information. The remote device 22 may alternatively or additionally output one of more of the following to a user: predetermined threshold probabilities (see below), the state of a connection actuator (see below), electrical power data (for detecting a power cut for example), generator or battery status (where a generator or battery is being used to power any component of the system), or any other information relevant to operation of the system. The interface may allow a user to control the jacking system remotely using the remote device 22. Alternatively or additionally, the user may remotely isolate or connect services using the connection actuator 20, or set system parameters such as the predetermined threshold probabilities.

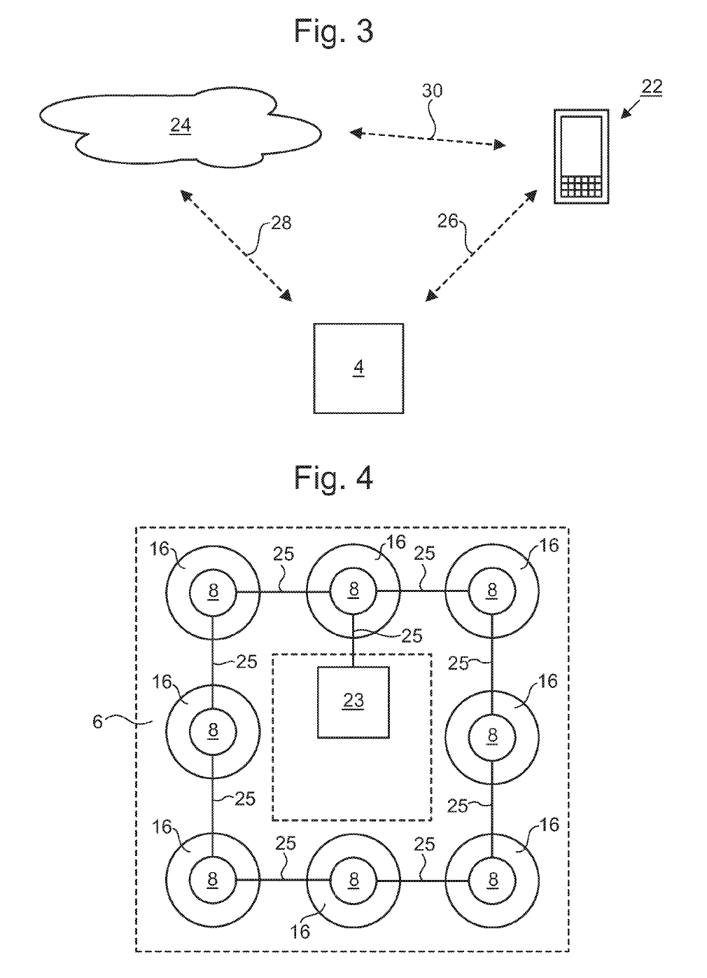

The remote device 22 communicates with the controller 4 using a conventional data connection (e.g. via the internet or a cellular network). FIG. 3 illustrates schematically how the controller 4 may communicate via path 26 (wired or wireless) with the remote device 22. FIG. 3 also shows how the remote device 22 may communicate via path 30 (wired or wireless) with an external data source in “cloud” 24 (e.g. to obtain meteorological data or to outsource data processing tasks), and how the controller 4 may communicate via path 28 (wired or wireless) with the external data source in cloud 24 (e.g. to obtain meteorological data or to outsource data processing tasks).

In an embodiment the data about one or more physical properties of the environment comprises information obtained by the controller 4 from the external data source 24. The external data source may provide meteorological data. The meteorological data may include flood alerts, weather forecasts and other information relating to current and predicted environmental conditions such as precipitation, cloud cover, water levels, temperature, wind and humidity. For example, the Environment Agency in the UK provides live flood warning information, three day flood forecasts and current risk information from groundwater, rivers and sea levels. The controller 4 may automatically alter the vertical position of the building 2 using either or both of data received from the one or more sensors 18 and the meteorological data from the external data source 24.

In an embodiment, the controller 4 is capable of operating in a low-power standby state and is configured to respond to data input to the controller 4 (e.g. from one or more of: the one or more sensors 18, the remote device 22, and the external data source 24) by entering a higher power state in which the controller 4 assesses whether the vertical position of the building 2 should be changed. For example, the controller 4 may be configured to respond to a flood alert received from the external data source 24 by entering the higher power state. The higher power state may comprise activating the one or more sensors 18 and/or analyzing data received from the one or more sensors 18. The provision of such a low-power standby state allows the controller 4 to remain in a low-power state when the flood risk is low, thus reducing power consumption and environmental impact. Alternatively or additionally, the meteorological data may be obtained by the remote device 22 to provide additional information to a user controlling the jacking system from the remote device 22 and/or the meteorological information may be relayed from the external data source 24 to the controller 4 via the remote device 22.

One or more service supply lines 21 (e.g. conduits or cables) may lead to the building 2 in order to provide services such as water, gas, electricity and drainage. Flexible connectors 22 (e.g. coiled conduits or cables) are provided for allowing the services to run into the building without the connections being interrupted by a changing vertical position of the building 2. However, in extreme flooding or environmental conditions, including for example situations where the building 2 is lifted by a great amount, there may be a risk of the service connections being broken. Sensors may be provided which detect such interruption. In an embodiment, a connection actuator 20 is provided which allows the service supply lines 21 to be selectively connected to and disconnected from the building 2. Thus, the connection actuator 20 allows selected services to be isolated from the building 2. In an embodiment the connection actuator 4 is controllable by the controller 4 and can therefore be actuated automatically in respond to information available to the controller 4 or in response to calculations performed by the controller 4.

In addition to the service supply lines, a sewerage system may be provided to the building 2. In an embodiment, the sewerage system may preferably comprise a vertical exit pipe from the building placed inside a vertical ground pipe. The vertical exit pipe may preferably have a smaller diameter than the vertical ground pipe, and is preferably situated inside the vertical ground pipe. Thus a sewerage system may be provided which provides effective and safe removal of sewage from the building irrespective of the vertical position of the building. The vertical exit pipe and the vertical ground pipe may optionally be connected by a flexible sewerage sleeve. The flexible sewerage sleeve may fit over both the vertical exit pipe and vertical ground pipe, to provide a continuous seal and improve environmental safety. For example, the flexible sewerage sleeve may be extended when the vertical position of the building is at a maximum, and may fold into the vertical ground pipe when the vertical position of the building is at a minimum.

1. A system for controlling the vertical position of a building, comprising:
a jacking system capable of moving the building vertically relative to a foundation structure supporting the weight of the building, wherein the jacking system comprises at least one screw jack.

2. The system of claim 1, further comprising:
one or more vertical members, each comprising a rigid vertical channel that is fixed relative to the foundation structure; and
one or more bearings, each fixed to the building and configured to only press against a surface of the channel when a lateral position of the bearing deviates by a threshold amount from a target lateral position, thereby transmitting a lateral stabilizing force to the building via the vertical member.

3. The system of claim 2, wherein each of the one or more vertical members comprises a single rigid vertical channel facing the building.

4. The system of claims 3, wherein the single rigid vertical channel comprises a base surface and side surfaces, and the bearing has a first component that engages rotatably with the base surface and a second component that engages rotatably with at least one of the side surfaces.

5. The system of any of claims 1 to wherein the at least one screw jack comprises a plurality of screw jacks and the jacking system comprises a coupling mechanism configured to cause all of the plurality of screw jacks to rise or fall at the same rate when driven by a single power source.

6. The system of claim 5, wherein each of the plurality of screw jacks is fixedly attached to the foundation structure.

7. The system of claim 6, wherein the foundation structure comprises a plurality of substructures, and each screw jack is fixedly attached to a different one of the plurality of substructures.

8. The system of claim 1, further comprising a controller configured to use the jacking system to control the vertical position of the building in response to data about one or more physical properties of the environment in or around the building input to the controller.

9. A system for controlling the vertical position of a building, comprising:
a jacking system capable of moving the building vertically relative to a foundation structure supporting the weight of the building; and
a controller configured to use the jacking system to control the vertical position of the building in response to data about one or more physical properties of the environment in or around the building input to the controller.

10. The system of claim 8, further comprising one or more sensors and wherein said data about one or more physical properties of the environment comprises data obtained from the one or more sensors.

11. The system of claim 10, wherein the controller is configured to transmit data received from the one or more sensors to a remote device.

12. The system of claim 11, wherein the remote device is configured to provide an output to a user based on the data received from the one or more sensors and to provide an interface configured to allow a user to control the jacking system remotely.

13. The system of claim 8, wherein said physical property comprises a water level, temperature, air humidity or ground humidity.

14. The system of claim 8, wherein said data about one or more physical properties of the environment comprises information obtained by the controller from an external data source providing meteorological data.

15. The system of claim 8, further comprising a connection actuator configured to selectively connect to, and disconnect from, the building an external service supply line leading to the building, wherein the connection actuator is controllable by the controller.

16. The system of claim 8, wherein the controller is configured such that the vertical position of the building is increased from a first vertical position to a second vertical position when the controller determines, based on said data input to the controller, that a probability of flood water reaching a first reference point in the building, if the building were to remain at the first vertical position during a first reference time period, exceeds a first predetermined threshold probability.

17. The system of claim 16, wherein the second vertical position is such that a probability of flood water reaching the first reference point in the building, if the building were to remain at the second vertical position for the first reference time period, is less than a second predetermined threshold probability.

18. The system of claim 8, wherein the controller is configured such that the vertical position of the building is decreased from a third vertical position to a fourth vertical position when the controller determines, based on said data input to the controller, that a probability of flood water reaching a second reference point in the building, if the building were to remain at the fourth vertical position for a second reference time period, is less than a third predetermined threshold probability.

19. The system of claim 8, wherein said physical property comprises temperature and the controller is configured such that if the controller determines that the building should be lifted, the height to which the building is lifted is lower if the temperature is determined to be below a predetermined temperature threshold than if the temperature is determined to be above the predetermined temperature threshold.

20. A method of controlling the vertical position of a building, comprising:
using a jacking system comprising at least one screw jack to move the building vertically relative to a foundation structure supporting the weight of the building.

21-34. (canceled)
